(19) United States
(12) Patent Application Publication
(10) Pub. No.: US 2024/0327735 A1
(43) Pub. Date: Oct. 3, 2024

(54) Syngas Yield Enhancement In Converting Carbonaceous Feeds By Gasification And Other Oxidative Methods

(71) Applicant: GTI Energy, Des Plaines, IL (US)

(72) Inventors: Zaher EL ZAHAB, Orlando, FL (US); Bo LI, Glendale, CA (US); Anthony EASTLAND, Moorpark, CA (US); Johan VAN DYK, Vanderbijlpark (ZA)

(21) Appl. No.: 18/581,867

(22) Filed: Feb. 20, 2024

Related U.S. Application Data
(60) Provisional application No. 63/446,978, filed on Feb. 20, 2023.

(51) Int. Cl. C10K 3/02; C10J 3/48; C10J 3/72; C10K 3/00

(52) U.S. Cl. CPC C10K 3/026; C10J 3/48; C10J 3/72; C10K 3/005; C10K 3/006; C10J 2300/0916; C10J 2300/0959; C10J 2300/0976; C10J 2300/1618; C10J 2300/1807; C10J 2300/1838; C10J 2300/1846; C10J 2300/1853; C10J 2300/1884

(57) ABSTRACT

Processes are disclosed that utilize beneficial reactions downstream of carbonaceous feed (e.g., biomass) oxidative conversion technologies, and advantageously under conditions (e.g., high temperatures) and/or with the syngas effluent quality (e.g., having particulates and/or other impurities) characteristic of raw syngas exiting such technologies (e.g., prior to, or upstream of, certain syngas purification operations). Such conversion technologies utilize an oxygen-containing feed or, more broadly, an oxidant-containing feed. The beneficial reactions may be carried out by the introduction of hydrogen for performing the reverse water-gas shift (RWGS) reaction and/or by the introduction of one or more hydrocarbons (e.g., methane, ethane, and/or propane) for performing the dry reforming reaction. These and other reactions can advantageously adjust the composition of the syngas obtained (e.g., as the raw syngas from an oxidative conversion technology) in a manner benefitting its subsequent use in providing value-added products such as liquid hydrocarbons.

### CROSS REFERENCE TO RELATED APPLICATIONS

This application claims the benefit of priority to U.S. Provisional Application No. 63/446,978, filed Feb. 20, 2023, which is hereby incorporated by reference in its entirety.

### FIELD OF THE INVENTION

The invention relates in general to increasing carbon utilization from carbonaceous feedstocks converted by oxidative processes, such as in gasification systems, partial oxidation (POX) systems, and autothermal reforming (ATR) systems.

### DESCRIPTION OF RELATED ART

A key commercial process for converting methane, biomass, coal, or other carbonaceous feedstocks into fuels involves a first conversion step to produce synthesis gas (syngas), followed by a second, downstream Fischer-Tropsch (FT) conversion step. With respect to the first conversion step, known processes for the production of syngas include partial oxidation (POX) reforming and autothermal reforming (ATR), based on the exothermic oxidation of methane with oxygen. Steam methane reforming (SMR), in contrast, uses steam as the oxidizing agent, such that the thermodynamics are significantly different, not only because the production of steam itself can require an energy investment, but also because reactions involving methane and water are endothermic. More recently, it has also been proposed to use carbon dioxide as the oxidizing agent for methane, such that the desired syngas is formed by the reaction of carbon in its most oxidized form (CO₂) with carbon in its most reduced form (CH₄). This reaction has been termed the “dry reforming” of methane, and because it is highly endothermic, thermodynamics for the dry reforming of methane are less favorable compared to ATR or even SMR. Gasification and pyrolysis have also been in extensive use for converting both renewable and non-renewable sources of carbon (e.g., biomass and coal) into syngas.

It is desirable to bring down the capital expenditures (CAPEX) as well as operational expenditures (OPEX) required for developing, operating, and maintaining gasification-based facilities that utilize syngas as an intermediate building-block to produce transportation fuels, chemicals, reduction gas for iron/steel, and power. To satisfy this desire, there are ongoing efforts in the art directed to integration of two or more unit operations of processes for converting carbonaceous feeds, in terms of their heat and/or material transport. Successfully implementing such process integration, while also realizing improvements in the facility overall performance and reliability, remains a significant challenge.

### SUMMARY OF THE INVENTION

The invention relates generally to the maximization of carbon utilization from carbonaceous feedstocks fed into various systems, including those that utilize oxidation, such as gasification systems, POX systems, and ATR systems.

The invention further relates to the surprising discovery that beneficial reactions can be performed downstream of carbonaceous feed (e.g., biomass) conversion technologies, and advantageously under conditions (e.g., high temperatures) and/or with the syngas effluent quality (e.g., having particulates and/or other impurities) characteristic of raw syngas exiting such technologies (e.g., prior to, or upstream of, certain syngas purification operations). Such conversion technologies are preferably oxidative conversion technologies that utilize an oxygen-containing feed or, more broadly, an oxidant-containing feed. For example, beneficial reactions may be carried out by the introduction of hydrogen for performing the reverse water-gas shift (RWGS) reaction and/or by the introduction of one or more hydrocarbons (e.g., methane, ethane, and/or propane) for performing the dry reforming reaction. These and other reactions can advantageously adjust the composition of the syngas obtained (e.g., as the raw syngas from an oxidative conversion technology) in a manner benefitting its subsequent use in providing value-added products such as liquid hydrocarbons. For example, in some embodiments, the introduction of hydrogen to perform the RWGS reaction can increase the syngas CO concentration. In other embodiments, the introduction of hydrocarbon(s) to perform the dry reforming reaction can increase both the syngas H₂ and CO concentrations. Importantly, the requirement of fixed-bed catalyst systems for performing the RWGS or dry reforming reactions, such as in separate reactors external to the gasifier or other vessel used to carry out the conversion of the carbonaceous feed to syngas (e.g., according to an oxidative conversion technology), may be avoided in preferred embodiments. To the extent that the use of dedicated catalysts for these reactions may not be necessary, they may be considered non-catalytic, although it is understood that metal-containing particulates, originating from the carbonaceous feed, may be present and thereby impart some catalytic activity. In other embodiments, catalyst particles may be added with the hydrogen and/or hydrocarbon(s) introduced, in view of a downstream filtration operation (e.g., in a separate filtration zone) that may be used in any event to filter solid particles, as needed for further conversion processes (e.g., Fischer-Tropsch synthesis). That is, downstream filtration may represent one of a number of possible downstream purification operations, as needed to properly “condition” the syngas for subsequent conversion or separation operations to produce a respective renewable syngas conversion product (e.g., purified hydrogen) or renewable syngas separation product (e.g., liquid hydrocarbons, methanol, or renewable natural gas).

To the extent that reactions such as RWGS and/or dry reforming may be performed under conditions and/or with the raw syngas quality, which is/are characteristic of direct effluents of oxidative conversion technologies such as gasification, in some embodiments a zone for performing these reactions may be within the same vessel as a zone for performing such oxidative conversion technologies, hereinafter also referred to as a “base technology.” For example, an RWGS reaction zone or a dry reforming reaction zone, in either case also constituting a CO₂ reduction zone, may be within the same vessel as a gasification zone, POX zone, or ATR zone, and positioned immediately downstream of such respective gasification zone, POX zone, or ATR zone. An RWGS reaction zone or a dry reforming reaction zone, as a CO₂ reduction zone, may also be positioned downstream of a zone for the thermal destruction of tars and oils (e.g., a tar removal zone), between the zone for performing the base technology (e.g., the gasification zone) and the CO₂ reduction zone.

Advantageously, a CO₂ reduction zone may be positioned upstream of other zones used for processing the effluent (e.g., raw syngas) obtained from oxidative conversion technologies such as gasification. These other zones may include a syngas cooling zone, for example implementing direct heat exchange with quench water or indirect, such as radiant or convective, heat exchange with boiler feed water. These other zones may also include, alternatively or in combination, a filtration zone of a filtration operation, for filtering solid particles present the raw syngas, and/or a scrubbing zone of a scrubbing operation, for removal of water-soluble contaminants (e.g., chlorides) present in the raw syngas. Syngas cooling, filtration, and/or scrubbing may be performed in vessels separate from one or more vessels for performing the base technology (e.g., gasification) and/or separate from one or more vessels of a tar removal zone that may be configured immediately downstream of the one of more vessels for performing the base technology. A tar removal zone may be useful for converting tars and oils that would otherwise be present in raw syngas exiting the base technology, which tars and oils refer to undesired hydrocarbons and oxygenated hydrocarbons having molecular weights greater than that of methane.

A CO₂ reduction zone may be incorporated in the same vessel for performing the base technology (e.g., gasification) or in the same vessel of a tar removal zone following the base technology, with such CO₂ reduction zone nonetheless being configured upstream of a syngas cooling zone, a filtration zone, and/or a scrubbing zone, each of which cooling, filtration, and scrubbing zones may utilize vessels that are separate from a vessel used for the CO₂ reduction zone and that are also separate from each other. That is, syngas cooling, filtration, and/or scrubbing may be performed in vessels separate from a vessel used to perform the base technology in one zone (e.g., a gasification zone) of the vessel and CO₂ reduction in another zone (e.g., a CO₂ reduction zone) of the same vessel, optionally with tar removal being performed between zones. In other embodiments, a CO₂ reduction zone may be incorporated in a separate vessel from that used for performing the base technology (e.g., gasification) and/or in a separate vessel from that used for performing tar removal (e.g., in a tar removal zone) following the base technology, with such CO₂ reduction zone nonetheless being configured upstream of a syngas cooling zone, a filtration zone, and/or a scrubbing zone, each of which cooling, filtration, and scrubbing zones may utilize vessels that are separate from a vessel used for the CO₂ reduction zone and that are also separate from each other. In this regard, whereas efficiencies arise from the ability to utilize a single vessel from multiple purposes/operations, such as by incorporating a CO₂ reduction zone into a vessel used for performing a base technology (e.g., gasification), optionally also in combination with tar removal, inventive aspects also relate, more generally, from the ability to conduct CO₂ reduction (whether or not incorporated into the same vessel for performing a different purpose/operation) prior to one or more other operations (e.g., cooling, filtration, and/or scrubbing) and thereby reduce overall utility (e.g., heating/cooling) requirements of the integrated process. For example, by positioning a CO₂ reduction zone (whether in the same vessel as, or in a different vessel from, a vessel used to perform gasification) upstream of a cooling zone, efficiencies are gained due to the avoidance of re-heating the cooled syngas exiting to cooling zone, as needed to achieve downstream CO₂ reduction in a separate reaction (e.g., fixed bed RWGS or dry reforming).

Particular aspects of the invention are associated with the discovery of integrated gasification and RWGS (e.g., being performed in the same vessel), which may be performed non-catalytically and by importing externally supplied H₂ from a hydrogen production process directly into the gasifier vessel, such as downstream of a gasification zone of this vessel, to reduce the CO₂ concentration (in an integrated CO₂ reduction zone) while increasing the CO concentration of the resulting CO₂-depleted syngas (or gasification syngas stream), optionally following its removal from a syngas cooling zone (FIG. 2). In addition to reducing the CO₂ via RWGS, the importation of externally supplied hydrogen can be controlled to supplement the hydrogen produced from gasification, hence driving the RWGS reaction and thereby increasing the overall useful syngas yield, such as used to produce transportation fuels, chemicals, reduction gas for iron/steel production, and/or power. A water splitting technique such as electrolysis may represent a specific hydrogen production process, for combining with gasification and RWGS (FIG. 3). Other hydrogen production processes that may be combined in this manner with gasification (or other oxidative conversion technology) and RWGS include steam methane reforming, methane pyrolysis, sorbent enhanced steam methane reforming, and others. In any such embodiment, RWGS may be performed catalytically, but in view of a favorable environment for RWGS, already existing in/created by the base technology (e.g., gasification), according to some embodiments RWGS or other CO₂-consuming reaction may advantageously be carried out non-catalytically or at least in the absence of added catalyst.

According to some embodiments, gasification may be integrated with dry reforming, optionally performed non-catalytically, by importing one or more externally supplied hydrocarbons (i.e., hydrocarbon types, such as methane, ethane, and/or propane) directly into the gasifier vessel, for example downstream of the gasification zone, to reduce the CO₂ concentration while increasing both the CO and H₂ concentrations in the CO₂-depleted syngas (or gasification syngas stream, optionally following its removal from a syngas cooling zone (FIG. 4). To provide the one or more hydrocarbons to the gasifier vessel at a temperature sufficient for the dry reforming reactions to proceed at suitable rates, external pre-heating may be used. Externally supplied CO₂ can be also pre-mixed and co-injected with the one or more hydrocarbons to effect dry reforming reactions and increase the CO and H₂ content in the gasification syngas stream. In the case of a tar removal operation immediately following the base technology (e.g., gasification), the externally supplied hydrocarbons may be separate from a fuel source added to the tar removal operation for conversion of tars and oils by oxidation, cracking, and/or reforming, to additional H₂ and CO.

Advantages of the invention can reside in process intensification aspects, according to which the gasifier vessel houses a gasification process/zone, optionally a tar removal process/zone, and an RWGS process/zone (as a type of CO₂ reduction zone), to provide an in-situ one reactor process that can significantly reduce or minimize CAPEX. This allows for an alternative to having a catalytic RWGS reactor block being entirely removed from the plant configuration, thereby leading to significant reduction, compared to such alternative, in both the overall plant CAPEX as well as the overall plant OPEX, for example associated with the RWGS catalyst and the external heat needed for a separate RWGS reactor downstream of cooling, filtration, and/or scrubbing operations.

As shown and described in more detail below, in some aspects the invention may be associated with the creation of a link between a gasification process and an RWGS process, in order to increase or even maximize the carbon utilization from the carbonaceous feedstocks fed into the gasifier. The link is created, more particularly, through consumption of CO₂ otherwise present in the raw syngas and through utilization, in an in-situ RWGS process, externally supplied hydrogen to increase the CO yield and to supplement the H₂ content otherwise present in the raw syngas. In cases of the externally supplied H₂ originating from a water splitting process such as electrolysis, the oxygen from the water splitting process can be fully or partially utilized as an oxidant for gasification or other oxidative conversion technology. Ultimately, the CO₂-depleted syngas, having an increased concentration of CO and/or H₂ relative to raw syngas obtained in the absence of the CO-consuming reaction (e.g., RWGS or drying reforming), may be more effectively utilized in downstream processes such as Fischer-Tropsch, chemicals synthesis, direct reduction iron (DRI), and/or power generation.

Other advantages of the invention can also reside in process intensification aspects according to which the gasifier vessel houses a gasification process/zone, optionally a tar removal process/zone, and an RWGS process/zone (as a type of CO₂ reduction zone), to provide an in-situ one reactor process that can significantly reduce or minimize CAPEX. This allows for an alternative to having a catalytic dry reforming reactor block being entirely removed from the plant configuration, thereby leading to significant reduction, compared to such alternative, in both the overall plant CAPEX as well as the overall plant OPEX, for example associated with the dry reforming catalyst and the external heat needed a separate dry reforming reactor downstream of cooling, filtration, and/or scrubbing operations.

Integration strategies described herein, such as with catalytic or non-catalytic RWGS and/or dry reforming reactions, insofar as they relate to gasification processes, can be used to augment other base technologies for converting carbonaceous feeds (e.g., biomass), with the same or similar advantages. These base technologies include other oxidative conversion technologies in which an oxygen-containing feed, or more broadly an oxidant-containing feed, are contacted with such feeds for the production of syngas (or gaseous product comprising both H₂ and CO). Alternative base technologies, and more particularly oxidative conversion technologies, include, for example, POX processes or ATR processes for applications that involve carbonaceous feedstocks in solid, liquid, or gaseous states.

Other objects and advantages will be apparent to those skilled in the art from the following detailed description taken in conjunction with the appended claims and drawings.

### BRIEF DESCRIPTION OF THE DRAWINGS

A more complete understanding of the exemplary embodiments of the present invention and the advantages thereof may be acquired by referring to the following description in consideration of the accompanying figures, in which the same reference numbers are used to indicate the same or similar features.

FIGS. 1A and 1B provide schematics that illustrate the augmentation of feedstock carbon utilization from a gasification process via ex-situ catalytic RWGS (FIG. 1A) or ex-situ catalytic dry reforming (FIG. 1B).

FIG. 2 provides a schematic that illustrates the augmentation of feedstock carbon utilization from a gasification process via in-situ RWGS, optionally being performed non-catalytically and using externally supplied H₂.

FIG. 3 provides a schematic that illustrates the augmentation of feedstock carbon utilization from a gasification process via in-situ RWGS, optionally being performed non-catalytically, using externally supplied H₂ from a water splitting process.

FIG. 4 shows a schematic that illustrates the augmentation of feedstock carbon utilization from a gasification process via in-situ dry reforming, optionally being performed non-catalytically and using externally supplied hydrocarbons.

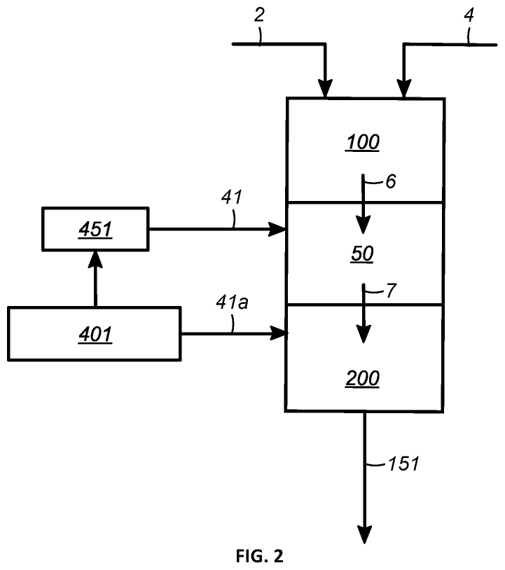

Whereas the figures illustrate multiple possible features that may be implemented individually or in any combination, not all features (e.g., not all individual operations and their associated process streams and equipment) are required in, or essential to, the practice of various inventive embodiments described herein. For example, according to the embodiment illustrated in FIG. 2, in some cases it may not be necessary to have a separate, second portion 41a of generated H₂ directed to syngas cooling zone 200 for direct syngas cooling. In such cases, all H₂ from hydrogen production process 401 may be preheated in hydrogen preheater 451 and utilized in CO₂ reduction zone 50. It should therefore be understood that various specific features can be implemented independently of others.

In order to facilitate explanation and understanding, the figures provide overviews of various features for implementation in processes, and particularly oxidative conversion technologies with integrated CO₂ reduction. Some associated equipment such as certain vessels, heat exchangers, valves, instrumentation, and utilities, are not shown, as their specific description is not essential with respect to the practice of various inventive embodiments. Such details would be apparent to those skilled in the art, having knowledge of the present disclosure. Other processes for integration of CO₂ reduction via RWGS or dry reforming, according to other embodiments within the scope of the invention and having configurations and constituents determined, in part, according to particular processing objectives, would likewise be apparent.

### DETAILED DESCRIPTION

Particular embodiments of the present invention are directed to approaches to reduce the CO₂ content in a syngas effluent from gasification, POX, or ATR processes, via in-situ non-catalytic RWGS. To enable the RWGS effect, external H₂ may be imported within the gasification, POX, or ATR reactor vessel downstream of the reaction zone (e.g., gasification zone, POX zone, or ATR zone) where the syngas is generated.

Representative processes comprise, in a conversion zone such as a gasification zone or other zone for converting a carbonaceous feed using an oxidative process, contacting the carbonaceous feed with an oxygen-containing gasifier feed (containing O₂) or oxidant-containing gasifier feed (e.g., containing H₂O and/or CO₂). More generally, in the case of oxidative conversion technologies other than gasification (e.g., POX or ATR), this oxygen-containing gasifier feed or oxidant-containing gasifier feed may simply be referred to as an oxygen-containing feed or an oxidant-containing feed. In any event, contacting is under gasification conditions or other oxidative process conditions, to provide a raw gasifier effluent or raw effluent of another oxidative process, namely raw syngas, which in any case comprises synthesis gas (i.e., syngas, comprising a mixture of H₂ and CO, together with optional other components). The processes may further comprise, in a CO₂ reduction zone downstream of the conversion zone, introducing a CO₂-consuming reactant to react with at least a portion of CO₂ present in the raw gasifier effluent or raw effluent of another oxidative process, via a CO₂-consuming reaction under CO₂-consuming reaction conditions, to provide a CO₂-depleted raw gasifier effluent or CO₂-depleted raw effluent of another oxidative process. The CO₂-depleted raw gasifier effluent or CO₂-depleted raw effluent of another oxidative process may alternatively be referred to as a “CO₂-depleted syngas” or “syngas having enhanced CO and/or H₂ concentration.” The CO₂-consuming reactant may be, for example, generated H₂ from a hydrogen production process or makeup hydrocarbons from a hydrocarbon source. The CO₂-consuming reactant may be preheated, prior to introduction into the CO₂ reduction zone or other zone, using any heat recovered (e.g., indirectly) from the conversion zone (e.g., oxidative conversion zone such as a gasification zone, POX zone, or ATR zone) and/or from a syngas cooling zone as described herein.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is wood (e.g., in the form of wood chips).

In a gasifier (or, more particularly, a gasification reactor of this gasifier), or in any other vessel used to house a reaction of another oxidative conversion technology, such as ATR or POX, the carbonaceous feed is subjected to partial oxidation in the presence of an oxygen-containing gasifier feed or oxidant-containing feed generally, added in an amount generally limited to supply only 20-70% of the oxygen that would be necessary for complete combustion. The oxygen-containing gasifier feed or oxidant-containing feed will, alternatively to or in combination with oxygen, generally comprise other oxygenated gaseous components including H₂O and/or CO₂ that may likewise serve as oxidants of the carbonaceous feed. The oxygen-containing gasifier feed or oxidant-containing feed can refer to all gases being fed or added to the gasifier, or otherwise can refer to gas that is separate from other gases being fed or added, whether subsequently combined upstream of, or within, the gasifier or other vessel used to house a reaction of another oxidative conversion technology (or simply “another oxidative process”). For example, the oxygen-containing gasifier feed or oxidant-containing feed may be introduced to the gasifier or other vessel, along with steam, or a portion of steam, generated elsewhere in the process (e.g., RSC-generated steam or CSC-generated steam from a radiant syngas cooler or convective syngas cooler) and used as a separate feed. Contacting of the carbonaceous feed with the oxygen-containing gasifier feed, or oxidant-containing feed, in the gasifier or other vessel provides a gasifier effluent or other effluent or effluent of another oxidative process, and more particularly a raw gasifier effluent or raw effluent of another oxidative process (i.e., raw syngas), as the product directly exiting the gasifier or other vessel, or otherwise exiting a zone of such gasifier or other vessel, as described herein. One or more reactors (e.g., in series or parallel) of the gasifier or other oxidative process may operate under conditions present in such reactor(s), with these conditions including a temperature of generally from about 500° C. (932° F.) to about 1500° C. (2732° F.), and typically from about 816° C. (1500° F.) to about 1000° C. (1832° F.). Other gasification conditions, or conditions of another oxidative process, may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi), or from about 0.5 MPa (72 psi) to about 2 MPa (290 psi).

The raw gasifier effluent, or raw effluent of another oxidative process (i.e., raw syngas), may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent, or raw effluent of another oxidative process (i.e., raw syngas), may be suitable, or may be adjusted to be suitable, for use in downstream syngas conversion operations (reactions or separations), such as (i) the conversion to a renewable syngas conversion product comprising higher molecular weight hydrocarbons and/or alcohols of varying carbon numbers via Fischer-Tropsch conversion or (ii) the conversion to a renewable syngas conversion product comprising methanol via a catalytic methanol synthesis reaction, or (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. Typically, the H₂:CO molar ratio desired for downstream conversion may be from about 0.5:1 to about 5:1, such as from about 1:1 to about 4:1 or from about 1:1 to about 3:1. According to preferred embodiments, a CO₂-consuming reaction described herein and/or other reaction(s) (e.g., a water-gas shift reaction) may be performed downstream of a base technology (e.g., gasification), either in-situ or ex-situ, and thereby adjust the H₂:CO molar ratio of the raw syngas to achieve a suitable H₂:CO molar ratio within these ranges.

For example, according to some embodiments, a CO₂-consuming reaction, such as RWGS or dry reforming, performed in a CO₂ reduction zone, may increase or decrease the H₂:CO molar ratio of the raw syngas and thereby provide a CO₂-depleted syngas with a higher or lower H₂:CO molar ratio, as desired for a downstream syngas conversion reaction. The adjustment may be an increase or decrease in this molar ratio, for example, generally from about 0.1 to about 2.5, typically from about 0.5 to about 2.0, and often from about 0.5 to about 1.5. Alternatively or optionally in combination with such adjustment of the H₂:CO molar ratio, the CO₂-consuming reaction may advantageously increase the concentration of one or both of H₂ and CO of the raw syngas and thereby provide a CO₂-depleted syngas with a higher concentration of these components, while decreasing the concentration of CO₂ relative to the raw syngas. For example, the concentration of one or both of H₂ and CO may be increased by at least about 1 mol-% (e.g., from about 1 mol-% to about 25 mol-%), at least about 2 mol-% (e.g., from about 2 mol-% to about 20 mol-%), or at least about 5 mol-% (e.g., from about 5 mol-% to about 15 mol-%), such that the overall yield of syngas is increased as a result of incorporating a CO₂ reduction zone.

Independently of, or in combination with, the representative amounts (concentrations) of H₂ and CO above, the gasifier effluent or effluent of another oxidative process (i.e., raw syngas) may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent or effluent of another oxidative process (i.e., raw syngas) may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent or effluent of another oxidative process (i.e., raw syngas). That is, these non-condensable gases and any water may be present in the gasifier effluent, or effluent of another oxidative process (i.e., raw syngas), in a combined amount of at least about 90 mol-%, at least about 95 mol-%, or even at least about 99 mol-%.

Concentration ranges given above for individual components or combinations of components, to the extent that they are described with respect to raw syngas, are likewise applicable, in certain embodiments, to the CO₂-depleted syngas following a CO₂-consuming reaction performed in a CO₂ reduction zone.

In general, tar removal, and more particularly tar conversion reactions, may be performed downstream of, and under higher temperatures compared to those used in, the gasifier or other oxidative process, such that the tar-depleted gasifier effluent, obtained directly from the tar removal operation, may have a temperature of greater than about 1000° C. (e.g., from about 1000° C. (1832° F.) to about 1500° C. (2732° F.), such as from about 1204° C. (2200° F.) to about 1427° C. (2600° F.)). As described above, tar removal may be performed by adding a fuel source for conversion of tars and oils by oxidation, cracking, and/or reforming, to additional H₂ and CO. Tar removal may be distinguishable from adding makeup hydrocarbons to a CO₂ reduction zone, for example on the basis of that latter, CO₂-consuming reaction resulting in more significant changes to the H₂:CO molar ratio, H₂ concentration, and/or CO concentration of the CO₂-depleted syngas relative to the raw syngas, as described above.

In view of certain advantages that may be gained from performing a CO₂-consuming reaction (e.g., RWGS by reaction with H₂ and/or dry reforming by reaction with one or more hydrocarbons) under conditions and/or with the raw syngas quality characteristics representative of oxidative conversion technologies such as gasification, it can be appreciated that, according to certain embodiments, gasification conditions, or conditions of another oxidative process, as described herein, may be representative of CO₂-consuming reaction conditions. These conditions include temperatures of effluents (e.g., raw syngas) described herein and obtained from gasification or other oxidative processes, as well as temperatures of effluents described herein and obtained from a tar removal operation. Likewise, any features pertaining to compositions of effluents obtained from gasification or other oxidative processes may be representative of CO₂-depleted syngas obtained from CO₂-consuming reactions, cooled effluents obtained from syngas cooling (e.g., in a syngas cooling zone), or filtered effluents obtained from filtration (e.g., in a filtration zone).

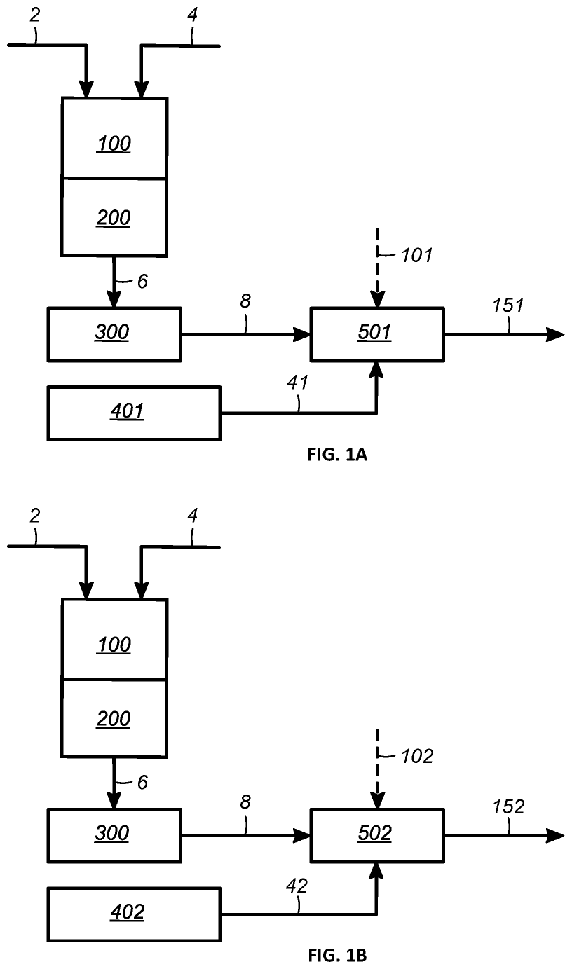

FIG. 1 depicts an overall process through which the CO₂ content in a gasification syngas effluent, i.e., raw syngas 6, may be reduced via an ex-situ catalytic RWGS process. Oxidant-containing feed 2 and carbonaceous feed 4 are introduced to oxidative conversion zone 100, such as a gasification zone, for example via pneumatic and/or mechanical methods. Components of carbonaceous feed become devolatilized due to the heat in oxidative conversion zone 100, then become partially combusted oxidant(s) such as oxygen in oxidant-containing feed 2, and thereafter become gasified in a reducing environment. The devolatilization, oxidation and reduction reactions in oxidative conversion zone 100, such as a gasification zone, lead to the feedstock conversion to syngas that primarily includes CO, H₂, CO₂, and H₂O, for example in the case of an oxygen-blown gasifier, and CO, H₂, CO₂, H₂O, and nitrogen (N₂) in the case of an air-blown or enriched-air-blown gasifier. The syngas effluent from the oxidative conversion zone 100 then enters syngas cooling zone 200 where it is cooled via direct and/or indirect quench methods that brings the gasification syngas effluent, or raw syngas 6, temperature to drop to an acceptable level for the physical integrity and safety of the downstream equipment and hardware. Thereafter, raw syngas 6 may undergo downstream syngas purification operation(s) 300, such as filtration and/or scrubbing to ensure the removal of undesirable particulates and trace contaminants (e.g., water-soluble contaminants such as HCl, NH₃, and HCN), to accommodate further downstream processing of the resulting, clean syngas 8.

For example, according to FIG. 1A, clean syngas 8 from downstream syngas purification operation(s) 300 (e.g., filtration and/or scrubbing) may be subjected to catalytic CO₂-consuming reaction 501, which may include a catalytic RWGS reactor for reaction of clean syngas 8 with externally supplied, or generated H₂ 41 from hydrogen production process 401, to reduce the CO₂ content in clean syngas 8 while producing additional CO and H₂O that may be recovered in CO₂-depleted syngas 151, which may have an enhanced CO yield/concentration. External heat 101 may be required for catalytic RWGS reactor 501. According to FIG. 1B, clean syngas 8 from downstream syngas purification operation(s) 300 (e.g., filtration and/or scrubbing) may be subjected to catalytic CO₂-consuming reaction 502, which may include a catalytic dry reforming reactor for reaction of clean syngas 8 with externally supplied, or makeup hydrocarbons (CₓH_{y}) 42 from hydrocarbon source 402, to reduce the CO₂ content in clean syngas 8 while producing additional CO and H₂ that may be recovered in CO₂-depleted syngas 152, which may have enhanced yields/concentrations of both H₂ and CO. External heat 102 may be required for catalytic dry reforming reactor 502.

As best shown in FIG. 2, according to one embodiment of the invention, the CO₂ content of raw syngas 6 from oxidative conversion zone (e.g., gasification zone) 100 may be innovatively reduced via an in-situ CO₂-reduction zone 50, in which a CO₂-consuming reaction such as RWGS is carried out, for example non-catalytically. Oxidant-containing feed 2 and carbonaceous feed 4 are introduced to oxidative conversion zone 100, such as a gasification zone, for example via pneumatic and/or mechanical methods. Components of carbonaceous feed become devolatilized due to the heat in oxidative conversion zone 100, then become partially oxidized and/or combusted by oxidant(s) such as oxygen in oxidant-containing feed 2, and thereafter become gasified in a reducing environment. The devolatilization, oxidation and reduction reactions in oxidative conversion zone 100, such as a gasification zone, lead to the feedstock conversion to syngas that primarily includes CO, H₂, CO₂, and H₂O, for example in the case of an oxygen-blown gasifier, and CO, H₂, CO₂, H₂O, and nitrogen (N₂) in the case of an air-blown or enriched-air-blown gasifier.

The syngas effluent from oxidative conversion zone 100, as raw syngas 6, then enters CO₂ reduction zone 50 to undergo an in-situ RWGS reaction where it is reacted, for example non-catalytically, with externally supplied, generated H₂ 41, provided from hydrogen production process 401, in this case an RWGS process, optionally after being heated via hydrogen preheater 451. This reduces the CO₂ content in both (i) CO₂-depleted gasifier effluent 7 (or CO₂-depleted ATR effluent, or CO₂-depleted POX effluent, depending on the oxidative conversion process used) exiting CO₂ reduction zone 50 and (ii) CO₂-depleted syngas 151 exiting syngas cooling zone, relative to that in raw syngas 6, while producing additional CO and H₂O. CO₂-depleted syngas 151 has a cooler temperature relative to raw syngas 6 and CO₂-depleted gasifier effluent 7 (or CO₂-depleted ATR effluent, or CO₂-depleted POX effluent, depending on the oxidative conversion process used), but may have substantially the same composition as CO₂-depleted gasifier effluent 7. In this regard, according to such particular embodiments, CO₂-depleted syngas 151, may be referred to as a cooled, CO₂-depleted gasifier effluent (cooled gasifier effluent, cooled ATR effluent, or cooled POX effluent).

The generated H₂ 41 may be imported into CO₂ reduction zone 50 in a very controlled and safe manner that effectively reduces the syngas stream CO₂ concentration while maintaining a temperature in this zone that is sufficiently high for the RWGS reaction to proceed at kinetic rates, even in the absence of catalyst, in view of the syngas stream residence time in CO₂ reduction zone 50. As such, an external heat source, such as hydrogen preheater 451 can be utilized if required to heat up generated H₂ 41 to a target temperature before it is imported into CO₂ reduction zone 50. The syngas effluent from the CO₂ reduction zone 50 then enters syngas cooling zone 200 where it is cooled via direct and/or indirect quench methods that bring the gasification syngas effluent temperature to drop to an acceptable level for the physical integrity and safety of the downstream equipment and hardware. A second portion 41a of externally supplied, generated H₂ can be further imported into syngas cooling zone 200 to directly quench the syngas effluent from CO₂ reduction zone 50 and to simultaneously supplement the H₂ content in this syngas effluent. By the RWGS reaction, generated H₂ 41, optionally in combination with quenching, section portion 41a, can achieve a target or optimized H₂:CO molar ratio in the CO₂-depleted syngas 151, for example within a range as described above. In some embodiments, however, second portion 41a may be avoided, such that all H₂ from hydrogen production process 401, optionally following heating in hydrogen preheater, may be input to CO₂ reduction zone 50. As can be appreciated from FIG. 2, raw syngas 6 may be internal to a single vessel that contains both oxidative conversion zone 100 and CO₂ reduction zone 50, and also optionally syngas cooling zone 200. However, it is also possible for at least one, and possibly all of these zones 100, 50, 200 to constitute separate vessels that are maintained under separate operating conditions.

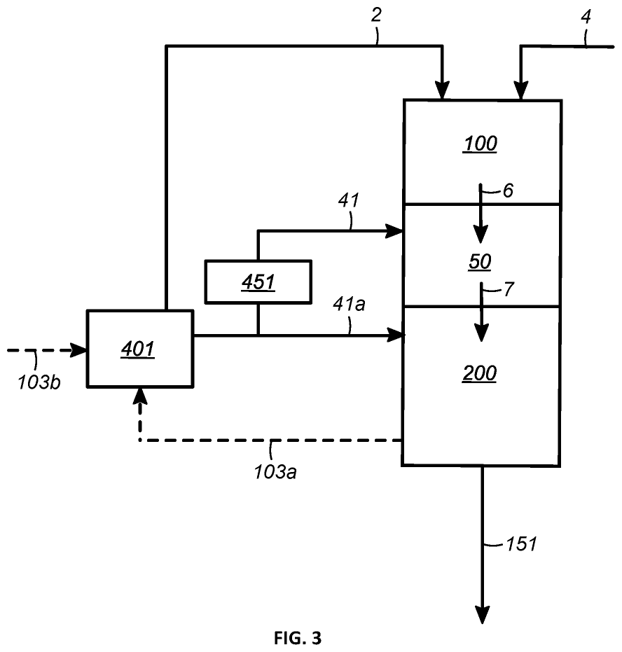

As best shown in FIG. 3, according to one embodiment of the invention, the CO₂ content of raw syngas 6 from oxidative conversion zone (e.g., gasification zone) 100 may be innovatively reduced via an in-situ CO₂-reduction zone 50, in which a CO₂-consuming reaction such as RWGS is carried out, for example non-catalytically and integrated with water splitting technologies such as electrolyzers to yield the needed hydrogen. Oxidant-containing feed 2 and carbonaceous feed 4 are introduced to oxidative conversion zone 100, such as a gasification zone, for example via pneumatic and/or mechanical methods. Components of carbonaceous feed become devolatilized due to the heat in oxidative conversion zone 100, then become partially oxidized and/or combusted by oxidant(s) such as oxygen in oxidant-containing feed 2, and thereafter become gasified in a reducing environment. The devolatilization, oxidation and reduction reactions in oxidative conversion zone 100, such as a gasification zone, lead to the feedstock conversion to syngas that primarily includes CO, H₂, CO₂, and H₂O, for example in the case of an oxygen-blown gasifier, and CO, H₂, CO₂, H₂O, and nitrogen (N₂) in the case of an air-blown or enriched-air-blown gasifier.

The syngas effluent from oxidative conversion zone 100, as raw syngas 6, then enters CO₂ reduction zone 50 to undergo an in-situ RWGS reaction where it is reacted, for example non-catalytically, with externally supplied, generated H₂ 41, provided from hydrogen production process 401, which is namely a water-splitting process, optionally after being heated via hydrogen preheater 451. This reduces the CO₂ content in both (i) CO₂-depleted gasifier effluent 7 (or CO₂-depleted ATR effluent, or CO₂-depleted POX effluent, depending on the oxidative conversion process used) exiting CO₂ reduction zone 50 and (ii) CO₂-depleted syngas 151 exiting syngas cooling zone, relative to that in raw syngas 6, while producing additional CO and H₂O. CO₂-depleted syngas 151 has a cooler temperature relative to raw syngas 6 and CO₂-depleted gasifier effluent 7 (or CO₂-depleted ATR effluent, or CO₂-depleted POX effluent, depending on the oxidative conversion process used), but may have substantially the same composition as CO₂-depleted gasifier effluent 7. In this regard, according to such particular embodiments, CO₂-depleted syngas 151, may be referred to as a cooled, CO₂-depleted gasifier effluent (cooled gasifier effluent, cooled ATR effluent, or cooled POX effluent).

The externally supplied, water splitting process generated H₂ 41 may be imported into CO₂ reduction zone 50 in a very controlled manner that effectively reduces the syngas stream CO₂ concentration while maintaining a temperature in this zone that is sufficiently high for the RWGS reaction to proceed at kinetic rates, even in the absence of catalyst, in view of the syngas stream residence time in CO₂ reduction zone 50. As such, an external heat source such as hydrogen preheater 451 can be utilized if required to heat-up the externally supplied water splitting process generated H₂ 41 to a target temperature before it is imported into CO₂ reduction zone 50. The syngas effluent from the CO₂ reduction zone 50 then enters the syngas cooling zone 200 where it is cooled via direct and/or indirect quench methods that bring the gasification syngas effluent temperature to drop to an acceptable level for the physical integrity and safety of the downstream equipment and hardware. A second portion 41a of the externally supplied water splitting process generated H₂ can be further imported into syngas cooling zone 200 to directly quench the syngas effluent from CO₂ reduction zone 50 and to simultaneously supplement the H₂ content in this syngas effluent. By the RWGS reaction, generated H₂ 41, optionally in combination with quenching, section portion 41a, can achieve a target or optimized H₂:CO molar ratio in the CO₂-depleted syngas 151, for example within a range as described above. In cases where the water splitting process requires heat as an input, indirectly recovered heat, such as process heat 103a from oxidative conversion zone 100 and/or syngas cooling zone 200 can be transferred as needed to hydrogen production process 401, which is namely a water-splitting process, in order to facilitate the water splitting process. If further necessary, external heat 103b can also be transferred to this process. In addition, further process integration can be realized if oxygen generated from water-splitting process is used to provide part or all of oxidant-containing feed 2. As can be appreciated from FIG. 3, raw syngas 6 may be internal to a single vessel that contains both oxidative conversion zone 100 and CO₂ reduction zone 50, and also optionally syngas cooling zone 200. However, it is also possible for at least one, and possibly all of these zones 100, 50, 200 to constitute separate vessels that are maintained under separate operating conditions.

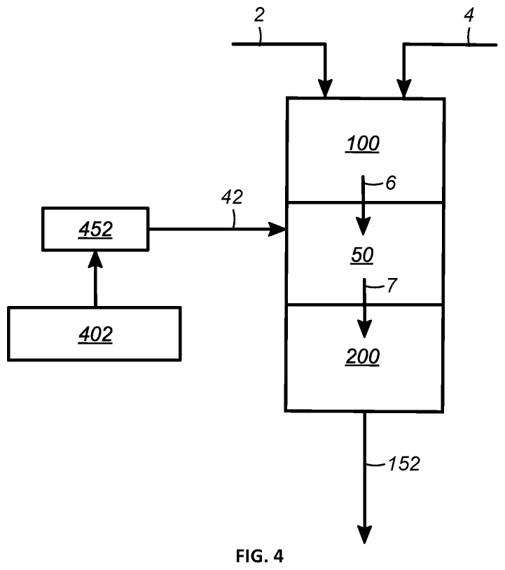

As best shown in FIG. 4, according to one embodiment of the invention, the CO₂ content of raw syngas 6 from oxidative conversion zone (e.g., gasification zone) 100 may be innovatively reduced via an in-situ CO₂-reduction zone 50, in which a CO₂-consuming reaction such as dry reforming is carried out, for example non-catalytically. Oxidant-containing feed 2 and carbonaceous feed 4 are introduced to oxidative conversion zone 100, such as a gasification zone, for example via pneumatic and/or mechanical methods. Components of carbonaceous feed become devolatilized due to the heat in oxidative conversion zone 100, then become partially oxidized and/or combusted by oxidant(s) such as oxygen in oxidant-containing feed 2, and thereafter become gasified in a reducing environment. The devolatilization, oxidation and reduction reactions in oxidative conversion zone 100, such as a gasification zone, lead to the feedstock conversion to syngas that primarily includes CO, H₂, CO₂, and H₂O, for example in the case of an oxygen-blown gasifier, and CO, H₂, CO₂, H₂O, and nitrogen (N₂) in the case of an air-blown or enriched-air-blown gasifier.

The syngas effluent from oxidative conversion zone 100, as raw syngas 6, then enters CO₂ reduction zone 50 to undergo an in-situ dry reforming reaction where it is reacted, for example non-catalytically, with externally supplied, makeup hydrocarbons 42, provided from hydrogen production process 402, in this case a dry reforming process, optionally after being heated via hydrocarbon preheater 452. This reduces the CO₂ content in both (i) CO₂-depleted gasifier effluent 7 (or CO₂-depleted ATR effluent, or CO₂-depleted POX effluent, depending on the oxidative conversion process used) exiting CO₂ reduction zone 50 and (ii) CO₂-depleted syngas 152 exiting syngas cooling zone, relative to that in raw syngas 6, while producing additional H₂ and CO. CO₂-depleted syngas 152 has a cooler temperature relative to raw syngas 6 and CO₂-depleted gasifier effluent 7 (or CO₂-depleted ATR effluent, or CO₂-depleted POX effluent, depending on the oxidative conversion process used), but may have substantially the same composition as CO₂-depleted gasifier effluent 7. In this regard, according to such particular embodiments, CO₂-depleted syngas 152, may be referred to as a cooled, CO₂-depleted gasifier effluent (cooled gasifier effluent, cooled ATR effluent, or cooled POX effluent).

The makeup hydrocarbons 42 may be imported into CO₂ reduction zone 50 in a very controlled and safe manner that effectively reduces the syngas stream CO₂ concentration while maintaining a temperature in this zone that is sufficiently high for the dry reforming reaction to proceed at kinetic rates, even in the absence of catalyst, in view of the syngas stream residence time in CO₂ reduction zone 50. As such, an external heat source, such as hydrocarbon preheater 452 can be utilized if required to heat up makeup hydrocarbons 42 to a target temperature before it is imported into CO₂ reduction zone 50. The syngas effluent from the CO₂ reduction zone 50 then enters syngas cooling zone 200 where it is cooled via direct and/or indirect quench methods that bring the gasification syngas effluent temperature to drop to an acceptable level for the physical integrity and safety of the downstream equipment and hardware. By the dry reforming reaction, makeup hydrocarbons 42 (e.g., methane, ethane, and/or propane) can achieve a target or optimized H₂:CO molar ratio in the CO₂-depleted syngas 152, for example within a range as described above. As can be appreciated from FIG. 4, raw syngas 6 may be internal to a single vessel that contains both oxidative conversion zone 100 and CO₂ reduction zone 50, and also optionally syngas cooling zone 200. However, it is also possible for at least one, and possibly all of these zones 100, 50, 200 to constitute separate vessels that are maintained under separate operating conditions.

Particular representative embodiments include the following: An integrated gasification and RWGS process to produce a syngas effluent, or CO₂-depleted syngas, from a gasifier vessel with reduced CO₂ content, wherein the gasifier includes at least three zones: a gasification zone for a carbonaceous feed (where drying, devolatilization, oxidation reactions, and gasification reactions take place), a CO₂ reduction zone, and a syngas cooling zone. H₂ may be added to the CO₂ reduction zone downstream of the gasification zone to reduce the CO₂ content in raw syngas from the gasification zone via RWGS reactions, optionally performed non-catalytically, to produce additional CO and H₂O. The syngas may be quenched in the syngas cooling zone via direct quench or indirect quench methods. According to any embodiment recited herein, the carbonaceous feed may be lignocellulosic feedstocks, agriculture waste, algae, organic wet waste, municipal solid waste (MSW), food waste, grain starch, oilseed crops, manure waste, coal, lignite, anthracite, and petcoke. The carbonaceous feed may be any gaseous or liquid matter such as natural gas, liquefied petroleum gas, flare gases, petroleum oil, tars, bio-oils, and biogas.

According to any embodiment recited herein, the gasification process and gasification zone may be substituted by another oxidative conversion process and associated oxidative conversion zone, such as POX process having a POX zone or an ATR process having an ATR zone.

According to any embodiment recited herein, externally sourced H₂ may be fed or imported into the syngas cooling zone to directly quench the syngas effluent from the oxidative conversion zone (gasification/POX/ATR zone) and simultaneously augment the H₂ content in the CO₂-depleted syngas from the syngas cooling zone in order to achieve a target or optimized H₂:CO molar ratio for downstream processes. This H₂ fed or imported into the CO₂ reduction zone, and/or into the syngas cooling zone, may be produced via a water splitting process such as electrolysis and the water splitting process oxygen byproduct may be fully or partially used to react with the carbonaceous feed in the gasifier, POX, or ATR process. The H₂ may be preheated to a target temperature, sufficient for gasification/POX/ATR, before being fed or imported into the CO₂ reduction zone. Oxygen needed in the gasification/POX/ATR zone may be fully or partially sourced from a source other than electrolysis such an air separation unit (ASU), a pressure swing adsorber (PSA), a vacuum pressure swing adsorber (VPSA), or an air separation membrane. The H₂ needed in the CO₂ reduction zone may otherwise be fully or partially sourced from one or more processes other than electrolysis such as a steam methane reforming, autothermal reforming, partial oxidation, gasification, and methane pyrolysis. Likewise, the H₂ fed or imported to the syngas cooling zone may be fully or partially sourced from one or more processes other than electrolysis such as a steam methane reforming, autothermal reforming, partial oxidation, gasification, and methane pyrolysis.

According to any embodiment recited herein, additional CO₂, not originating from the carbonaceous feed in the gasification/POX/ATR zone, may be fed or imported in the gasification/POX/ATR zone and/or the CO₂ reduction zone. Such additional CO₂ may originate from external point-source CO₂ capture facilities and/or direct air capture facilities, for feeding or importing into the gasification/POX/ATR zone and/or the CO₂ reduction zone. According to any embodiment recited herein, additional carbonaceous materials, not originating from the carbonaceous feed to the gasification/POX/ATR zone, may be fed to the gasification/POX/ATR zone and/or the CO₂ reduction zone. According to any embodiment recited herein, H₂O produced from the RWGS reaction in the CO₂ reduction zone may gasify and reform unconverted materials from the carbonaceous feedstocks fed to the gasification zone. Alternatively, or in combination, H₂O produced from the RWGS reaction in the CO₂ reduction zone may gasify and reform any external carbonaceous materials that are fed or imported into the gasification zone and/or the CO₂ reduction zone.

Other particular representative embodiments include the following: An integrated gasification and dry reforming process to produce a syngas effluent, or CO₂-depleted syngas, from a gasifier vessel with reduced CO₂ content, wherein the gasifier includes at least three zones: a gasification zone for a carbonaceous feed (where drying, devolatilization, oxidation reactions, and gasification reactions take place), a CO₂ reduction zone, and a syngas cooling zone. One or more hydrocarbons (e.g., methane, ethane, and/or propane) may be added to the CO₂ reduction zone downstream of the gasification zone to reduce the CO₂ content in the raw syngas from the gasification zone via dry reforming reactions, optionally performed non-catalytically, to produce more CO and H₂. The syngas may be quenched in the syngas cooling zone via direct quench or indirect quench methods. According to any embodiment recited herein, the carbonaceous feed may be lignocellulosic feedstocks, agriculture waste, algae, organic wet waste, municipal solid waste (MSW), food waste, grain starch, oilseed crops, manure waste, coal, lignite, anthracite, and petcoke. The carbonaceous feed may be any gaseous or liquid matter such as natural gas, liquefied petroleum gas, flare gases, petroleum oil, tars, bio-oils, and biogas.

According to any embodiment recited herein, the one or more hydrocarbons may be preheated to a target temperature, sufficient for gasification/POX/ATR, before being fed or imported into the CO₂ reduction zone. Externally supplied CO₂ may be pre-mixed and co-injected with the one or more hydrocarbons into the CO₂ reduction zone. Additional carbonaceous materials, not originating from the carbonaceous feed to the gasification/POX/ATR zone, may be fed to the gasification/POX/ATR zone and/or the CO₂ reduction zone.

Other particular representative embodiments include the following: an integrated gasification, in-situ RWGS process, and in-situ dry reforming process to produce a syngas effluent, or CO₂-depleted syngas, from a gasifier vessel with reduced CO₂ content, wherein the gasifier includes at least three zones: a gasification zone for a carbonaceous feed (where drying, devolatilization, oxidation reactions, and gasification reactions take place), a CO₂ reduction zone, and a syngas cooling zone. Hydrogen may be added to the CO₂ reduction zone downstream of the gasification zone to reduce the CO₂ content in the raw syngas from the gasification zone via RWGS reactions, optionally performed non-catalytically, to produce more CO and H₂O. One or more hydrocarbons (e.g., methane, ethane, and/or propane) may be added to the CO₂ reduction zone downstream of the gasification zone to reduce the CO₂ content in the syngas effluent from the gasification zone via dry reforming reactions, optionally performed non-catalytically, to produce additional CO and H₂. The syngas exiting the CO₂ reduction zone may be quenched in the syngas cooling zone via direct quench or indirect quench methods. The hydrogen and/or one or more hydrocarbons, which are optionally imported or supplied from on-site external processes, may be pre-heated to respective target temperatures, sufficient for gasification/POX/ATR, before being fed to the CO₂ reduction zone. Externally supplied CO₂ may be pre-mixed and co-injected with the hydrogen and/or one or more hydrocarbons into the CO₂ reduction zone.

According to any embodiment recited herein, the hydrogen, which is optionally imported or supplied from an on-site external process, may be fed to the syngas cooling zone to directly quench the syngas effluent from the gasification/POX/ATR zone and simultaneously augment the H₂ content in the syngas effluent from the syngas cooling zone in order to achieve a target or optimized H₂:CO molar ratio for downstream processes. The hydrogen added to the CO₂ reduction zone may be produced via a water splitting process such as electrolysis and the water splitting process oxygen by-product may be fully or partially used to react with the carbonaceous feed to the gasifier/POX/ATR. Hydrogen fed to the syngas cooling zone may be produced via a water splitting process such as electrolysis and the water splitting process oxygen byproduct may be fully or partially used to react with a carbonaceous feed to the gasifier/POX/ATR.

According to any embodiment recited herein, oxygen needed in the gasification/POX/ATR zone may be fully or partially sourced from a source other than electrolysis, such an air separation unit (ASU), a pressure swing adsorber (PSA), a vacuum pressure swing adsorber (VPSA), or an air separation membrane. Hydrogen fed to the CO₂ reduction zone and/or hydrogen fed to the syngas cooling zone, may be fully or partially sourced from processes other than electrolysis such as a steam methane reforming, autothermal reforming, partial oxidation, gasification, and methane pyrolysis.

Embodiments disclosed herein may be suitably practiced without further collaboration of additional elements, parts, steps, components, or ingredients of which those skilled in the art, having knowledge of the present disclosure, would be aware and would be capable of implementation. To the extent that associated equipment such as certain vessels, heat exchangers, valves, instrumentation, and utilities, are not shown, their specific description is not essential to the implementation or understanding of the various aspects of the invention. Such equipment would be readily apparent to those skilled in the art, having knowledge of the present disclosure.

Whereas in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles or science of the invention.

1. A process for conversion of a carbonaceous feed to syngas, the process comprising:
in an oxidative conversion zone that is a gasification zone, a partial oxidation (POX) zone, or an autothermal reforming (ATR) zone, contacting the carbonaceous feed with an oxygen-containing feed, under respective gasification conditions, POX conditions, or ATR conditions, to provide, as a raw syngas, a respective raw gasifier effluent, raw ATR effluent, or raw POX effluent;
in a CO₂ reduction zone downstream of the conversion zone, introducing a CO₂-consuming reactant to react with at least a portion of CO₂ present in the respective raw gasifier effluent, raw ATR effluent, or raw POX effluent, via a CO₂-consuming reaction under CO₂-consuming reaction conditions, to provide, as a CO₂-depleted syngas optionally following cooling in an CO₂ cooling zone, a respective CO₂-depleted gasifier effluent, CO₂-depleted ATR effluent, or CO₂-depleted POX effluent.

2. The process of claim 1, wherein the CO₂-consuming reactant is hydrogen or a hydrocarbon.

3. The process of claim 2, wherein the CO₂-consuming reactant is hydrogen and the CO₂-consuming reaction is a reverse water-gas shift (RWGS) reaction.

4. The process of claim 3, wherein the RWGS reaction is carried out non-catalytically.

5. The process of claim 2, wherein the CO₂-consuming reactant is hydrogen obtained from a hydrogen production process.

6. The process of claim 5, wherein the hydrogen production process is steam methane reforming or methane pyrolysis.

7. The process of claim 5, wherein the hydrogen, as the CO₂-consuming reactant, is a main hydrogen portion obtained from the hydrogen production process, and possibly wherein a secondary hydrogen portion obtained from the hydrogen production process is introduced to a syngas cooling zone, to which the respective CO₂-depleted gasifier effluent, CO₂-depleted ATR effluent, or CO₂-depleted POX effluent is fed for cooling.

8. The process of claim 7, wherein the first hydrogen portion, as the CO₂-consuming reactant, is preheated to a CO₂ reduction zone inlet temperature for introduction to the CO₂ reduction zone, which is higher than a syngas cooling zone inlet temperature, at which the second hydrogen portion is introduced to the syngas cooling zone.

9. The process of claim 8, wherein the CO₂ reduction zone inlet temperature is within 50° C., within 25° C., or within 10° C., of a minimum temperature in the CO₂ reduction zone for performing the CO₂-consuming reaction.

10. The process of claim 2, wherein the CO₂-consuming reactant is hydrogen obtained from a water-splitting process, such as an electrochemical water-splitting process, for example electrolysis, or a thermochemical water-splitting process such as chemical looping.

11. The process of claim 10, wherein the hydrogen, as the CO₂-consuming reactant, is a main hydrogen portion obtained from the water-splitting process, and possibly wherein a secondary hydrogen portion obtained from the water-splitting process is introduced to a syngas cooling zone, to which the respective CO₂-depleted gasifier effluent, CO₂-depleted ATR effluent, or CO₂-depleted POX effluent is fed for cooling.

12. The process of claim 7, wherein the first hydrogen portion, as the CO₂-consuming reactant, is preheated to a CO₂ reduction zone inlet temperature for introduction to the CO₂ reduction zone, which is higher than a syngas cooling zone inlet temperature, at which the second hydrogen portion is introduced to the syngas cooling zone.

13. The process of claim 11, wherein heat recovered from the conversion zone and syngas cooling zone is utilized in the water-splitting process.

14. The process of any claim 11, wherein, in addition to the CO₂-consuming reactant, the water-splitting process provides oxygen that is utilized as an oxidant in the conversion zone.

15. The process of claim 2, wherein the CO₂-consuming reactant is a hydrocarbon and the CO₂-consuming reaction is a dry reforming reaction.

16. The process of claim 15, wherein the dry reforming reaction is carried out non-catalytically.

17. The process of claim 15, wherein the CO₂-consuming reactant is methane, ethane, or propane.

18. The process of claim 15, wherein the hydrocarbon, as the CO₂-consuming reactant, is preheated to a CO₂ reduction zone inlet temperature, for introduction to the CO₂ reduction zone.

19. The process of claim 18, wherein the CO₂ reduction zone inlet temperature is within 50° C., within 25° C., or within 10° C., of a minimum temperature in the CO₂ reduction zone for performing the CO₂-consuming reaction.

20. The process of claim 1, wherein the CO₂-depleted gasifier effluent, CO₂-depleted ATR effluent, or CO₂-depleted POX effluent has a concentration of CO₂ that is lower than that in a raw syngas, as a respective raw gasifier effluent, raw ATR effluent, or raw POX effluent.

21-33. (canceled)

34. An integrated gasification and RWGS process to produce a syngas effluent, or CO₂-depleted syngas, from a gasifier vessel with reduced CO₂ content, wherein the gasifier vessel includes at least three zones: a gasification zone for a carbonaceous feed (where drying, devolatilization, oxidation reactions, and gasification reactions take place), a CO₂ reduction zone, and a syngas cooling zone, the process comprising:
adding H₂ to the CO₂ reduction zone downstream of the gasification zone to reduce the CO₂ content in raw syngas from the gasification zone via RWGS reactions, optionally performed non-catalytically, to produce additional CO and H₂O, and/or
adding one or more hydrocarbons (e.g., methane, ethane, and/or propane) to the CO₂ reduction zone downstream of the gasification zone to reduce the CO₂ content in the raw syngas from the gasification zone via dry reforming reactions, optionally performed non-catalytically, to produce additional CO and H₂,
wherein at least one of the gasification zone, CO₂ reduction zone, and syngas cooling zone constitutes a separate vessel relative to the other zones.

35. An integrated gasification, in-situ RWGS process, and in-situ dry reforming process to produce a syngas effluent, or CO₂-depleted syngas, from a gasifier vessel with reduced CO₂ content, wherein the gasifier vessel includes at least three zones: a gasification zone for a carbonaceous feed (where drying, devolatilization, oxidation reactions, and gasification reactions take place), a CO₂ reduction zone, and a syngas cooling zone, the process comprising:
adding hydrogen to the CO₂ reduction zone downstream of the gasification zone to reduce the CO₂ content in the raw syngas from the gasification zone via RWGS reactions, optionally performed non-catalytically, to produce more CO and H₂O, and/or
adding one or more hydrocarbons (e.g., methane, ethane, and/or propane) to the CO₂ reduction zone downstream of the gasification zone to reduce the CO₂ content in the syngas effluent from the gasification zone via dry reforming reactions, optionally performed non-catalytically, to produce additional CO and H₂,
wherein at least one of the gasification zone, CO₂ reduction zone, and syngas cooling zone are in a single vessel.
